(19) United States
(12) Patent Application Publication
(10) Pub. No.: US 2011/0177911 A1
(43) Pub. Date: Jul. 21, 2011

(54) Planetary gear mechanism for a bicycle

(76) Inventors: Alexander Serkh, Troy, MI (US); Dean Schneider, Washington, MI (US)

(21) Appl. No.: 12/657,461

(22) Filed: Jan. 20, 2010

(51) Int. Cl. F16H 3/46; F16H 57/10

(52) U.S. Cl. 475/277; 475/271; 475/297

(57) ABSTRACT

A planetary gear mechanism for a bicycle, and more particularly to a planetary gear mechanism comprising a first planetary mechanism connected coaxially in series to a second planetary mechanism, which second planetary mechanism is connected coaxially in series to a third planetary mechanism, the second planetary mechanism output is a step up in speed from the first planetary mechanism output, the third planetary mechanism output is a step up in speed from the second planetary mechanism output.

### FIELD OF THE INVENTION

The invention relates to a planetary gear mechanism for a bicycle, and more particularly to a planetary gear mechanism comprising a first planetary mechanism connected coaxially in series to a second planetary mechanism, which second planetary mechanism is connected coaxially in series to a third planetary mechanism, the second planetary mechanism output is a step up in speed from the first planetary mechanism output, the third planetary mechanism output is a step up in speed from the second planetary mechanism output.

### BACKGROUND OF THE INVENTION

It is known that bicycles may have internal geared transmissions located in rear hubs. For example, the Shimano Company provides a Shimano Nexus' eight speed transmission. The transmission comprises an internal geared planetary transmission which is located in a bicycle rear wheel hub. Rohloff GmbH of Germany provides a fourteen speed planetary gear transmission, also for use in a bicycle rear wheel hub.

The prior art transmissions have common disadvantages including heavy weight and that each is located in the bicycle rear wheel hub.

Also representative of the art is U.S. Pat. No. 6,468,178 (2002) to Mohtasham which discloses a rear wheel hub and chainless drive train gear assembly for use on a bicycle having an axle bracket fixed to the frame of the bicycle, a spindle extending axially through the axle bracket and left and right pedal crank arms for rotating the spindle upon application of a pedaling force. A primary drive gear fitted to the spindle drivingly engages carrier gears which operate a planet gear cage housing and a multiple planetary gear and sun gear arrangement according to various gear ratios determined by selective operation of a clutch assembly. Planetary gear groups each include an integral set of planetary gears of varying size which mesh with corresponding sun gear rings. Operation of the clutch assembly serves to selectively engage pawl stops with a corresponding sun gear ring, thereby engaging the corresponding sun gear ring with one of the planetary gears of the planetary gear groups according to a selected gear ratio. The planetary gear groups drive an annular gear ring and an associated annular needle bearing which, in a forward clockwise rotation, engages the hub body to rotate the rear bicycle wheel. Reverse rotation of the annular gear, in a counter-clockwise rotation, results in a freewheeling of the drive train gear assembly relative to the hub body.

What is needed is a planetary gear mechanism comprising a first planetary mechanism connected coaxially in series to a second planetary mechanism, which second planetary mechanism is connected coaxially in series to a third planetary mechanism, the second planetary mechanism output is a step up in speed from the first planetary mechanism output, the third planetary mechanism output is a step up in speed from the second planetary mechanism output. The present invention meets this need.

### SUMMARY OF THE INVENTION

The primary aspect of the invention is to provide a planetary gear mechanism comprising a first planetary mechanism connected coaxially in series to a second planetary mechanism, which second planetary mechanism is connected coaxially in series to a third planetary mechanism, the second planetary mechanism output is a step up in speed from the first planetary mechanism output, the third planetary mechanism output is a step up in speed from the second planetary mechanism output.

Other aspects of the invention will be pointed out or made obvious by the following description of the invention and the accompanying drawings.

The invention comprises a planetary gear mechanism comprising an input member (22), a first carrier (100) having a first carrier first pinion gear (P1) and a first carrier second pinion gear (P2), each journalled to the first carrier, the first carrier rotationally fixed to the input member (22), the first carrier second pinion gear (P2) in meshing engagement with sun gear S1 which is engaged with a first brake (Brake 1), a second carrier (200) having second carrier first pinion gear (P4) and a second carrier second pinion gear (P5), each pinion gear (P4) and (P5) is journalled to the second carrier, the second carrier engaged with a second brake (Brake 2), a first ring gear (R1) in meshing engagement with the first carrier first pinion gear (P1), a second ring gear (R2) in meshing engagement with the second carrier first pinion gear (P4), the first ring gear and second ring gear comprise a ring gear member (400), a third carrier (300) having a third carrier first pinion gear (P6) and a third carrier second pinion gear (P7), each pinion gear (P6) and (P7) is journalled to the third carrier, a third ring gear (R3) in meshing engagement with the second carrier second pinion gear (P5), the third ring gear fixedly connected to the third carrier (300), a fourth ring gear (R4) engaged with a third brake (Brake 3) and in meshing engagement with the third carrier first pinion gear (P6), a first one-way clutch (CL1) engaged between the first carrier (100) and the ring gear member (400), a second one-way clutch (CL2) engaged between the second carrier (200) and the ring gear member (400), a third one-way clutch (CL3) engaged between the third carrier (300) and the fourth ring gear (R4), and an output member (44) in meshing engagement with the third carrier second pinion gear (P7).

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional schematic view of the transmission.

FIG. 2 is a table of gear ratios.

FIG. 3 is a table of brake and clutch positions for each gear.

FIG. 4 is a partial side view of a bicycle.

FIG. 5 is a cross-sectional view of the transmission.

FIG. 6 is a perspective view of a brake.

FIG. 7 is a cross-section at 7-7 in FIG. 5.

FIG. 8 is a cross-section at 8-8 in FIG. 5.

FIG. 9 is a cross-section at 9-9 in FIG. 5.

FIG. 10 is a cross-section at 10-10 in FIG. 5.

FIG. 11 is a cross-section at 11-11 in FIG. 5.

FIG. 12 is a cross-section at 12-12 in FIG. 5.

FIG. 13 is a cross-section at 13-13 in FIG. 5.

### DETAILED DESCRIPTION OF THE PREFERRED EMBODIMENT

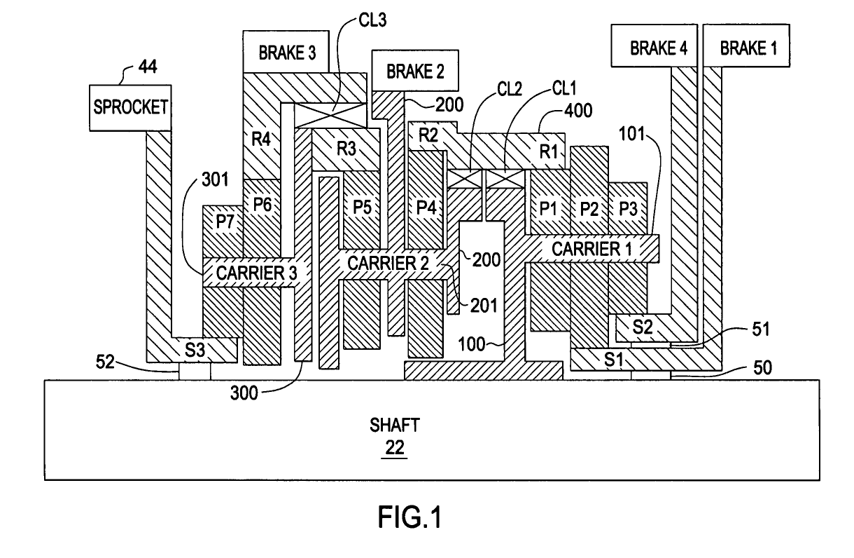

FIG. 1 is a cross-sectional schematic view of the transmission. The invention generally comprises a planetary gear mechanism having an input member connected to a first planetary mechanism, the first planetary mechanism connected coaxially in series to a second planetary mechanism, which second planetary mechanism is connected coaxially in series to a third planetary mechanism, the second planetary mechanism output is a step up in speed from the first planetary mechanism output, the third planetary mechanism output is a step up in speed from the second planetary mechanism output, and the third planetary mechanism connected to an output member.

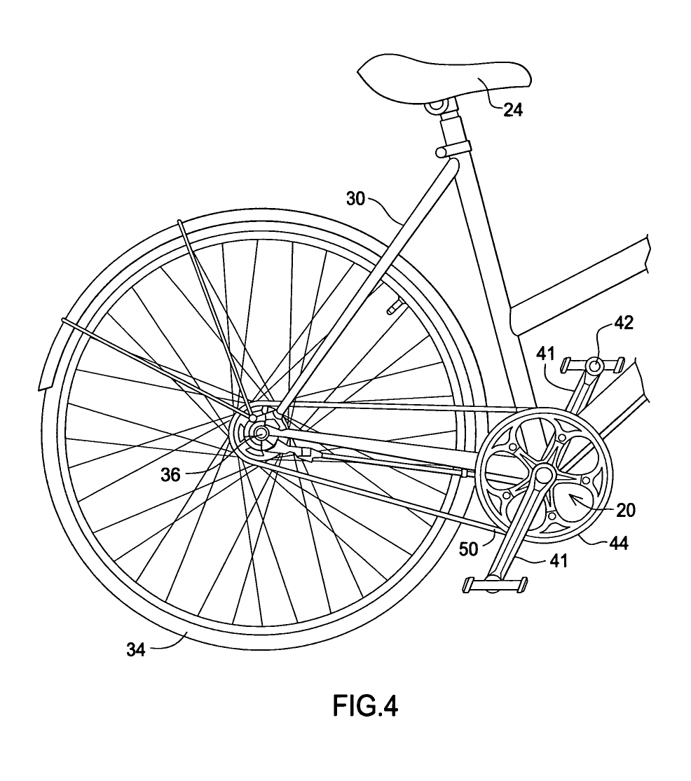

The proposed transmission is preferably located in a bicycle bottom bracket, see FIG. 4. Crank arms (see FIG. 4) are attached to each end of the input member 22. Carrier 100 is rigidly connected to the member 22, and thereby rotates with member 22. Carrier 100 further comprises a carrier pin or shaft 101.

Three planet pinion gears are journalled to pin 101, namely, P1, P2, P3. Each pinion gear P1, P2, P3 rotates together at the same speed about pin 101. Pinions P1, P2, P3 preferably comprise a single gear component having three different diameters, thereby describing gears P1, P2, P3.

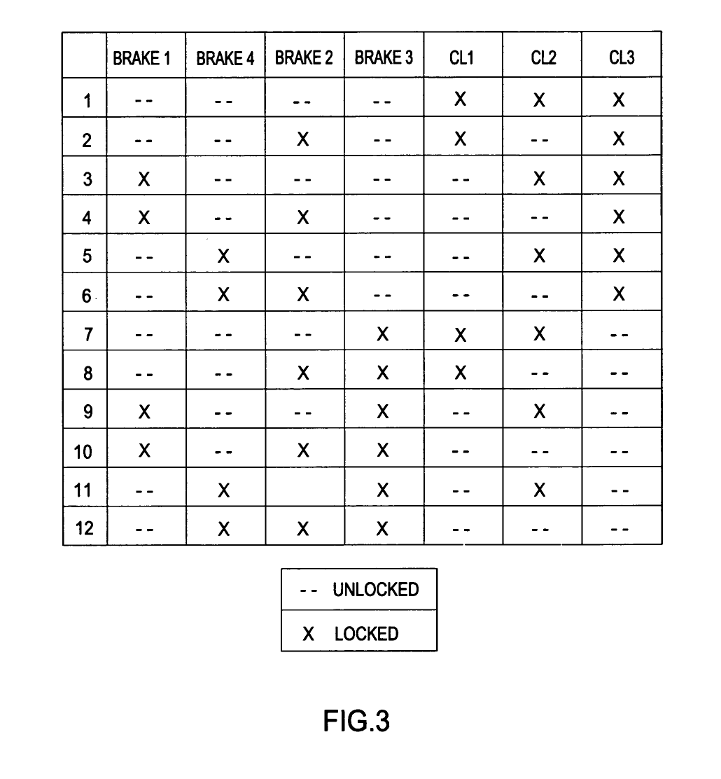

Ring gear member 400 comprises a first ring gear R1 and a second ring gear R2. R1 is in meshing connection with pinion P1. Sun gears S1 and S2 are in meshing engagement with pinion gears P2 and P3 respectively. Sun gears S1 and S2 are reaction gears with brake 1 and brake 4. Brake 1 and brake 4 are connected to a bicycle frame (see FIG. 4). The rotational speed of pinion P1 is a function of whether brake 1 or brake 4 is engaged or disengaged, see FIG. 3.

Second planetary mechanism has two pinion gears P4 and P5 fixedly connected to a carrier shaft 201, and therefore gears P4 and P5 rotate together with shaft 201. Ring gear R2 is in meshing engagement with pinion gear P4. Carrier shaft 201 is journalled to carrier 200. Carrier 200 is a reaction member with and is engaged with brake 2.

A third ring gear R3 is fixedly attached to the input member of the third planetary mechanism which is carrier 300. The third planetary mechanism pinion gear P6 is in meshing engagement with fourth ring gear R4. Ring gear R4 is engaged with brake 3 and one-way clutch CL3. One-way clutch CL3 is engaged with carrier 300 and ring gear R3.

Pinion gear P6 and P7 are each journalled to carrier pin 301, and therefore rotate together. Pinion gears P6 and P7 preferably comprise a single gear component having two different diameters and hence define gears P6 and P7. Pinion gear P7 is in meshing engagement with output sun gear S3. Output sun gear S3 is fixedly attached to output sprocket 44.

All planetary carrier mechanisms are numbered as a function of increasing speed of their respective output members, that is, the third planetary mechanism causes rotation of sprocket 44, which in turn rotates faster than the relative rotation of the second planetary mechanism, which in turn rotates faster than the relative rotation of the first planetary mechanism when each planetary mechanism is operating with all one-way clutches dis-engaged, see FIG. 3 gear 12. Further, each planetary carrier mechanism is coaxial with the others and each of the planetary carrier mechanisms are connected in series.

Each planetary mechanism further comprises a one-way clutch, namely, CL1, CL2, CL3. When engaged each one-way clutch locks each respective planetary carrier mechanism with a gear ratio of 1:1.

A low-friction bushing 50 is disposed between input member 22 and sun gear S1. A low-friction bushing 51 is disposed between sun gear S1 and sun gear S2. A low-friction bushing 52 is disposed between sun gear S3 and input member 22.

For ease of reference, the following assemblies may also be generally referred to as the first planetary mechanism, second planetary mechanism and third planetary mechanism.
First planetary mechanism: carrier 100; pinion gears P1, P2, P3; shaft 101; one-way clutch CL1; ring gear R1
Second planetary mechanism: carrier 200; pinion gears P4, P5; shaft 201; one-way clutch CL2; ring gear R2; ring gear R3
Third planetary mechanism: carrier 300; pinion gears P6, P7; shaft 301; one-way clutch CL3; ring gear R4

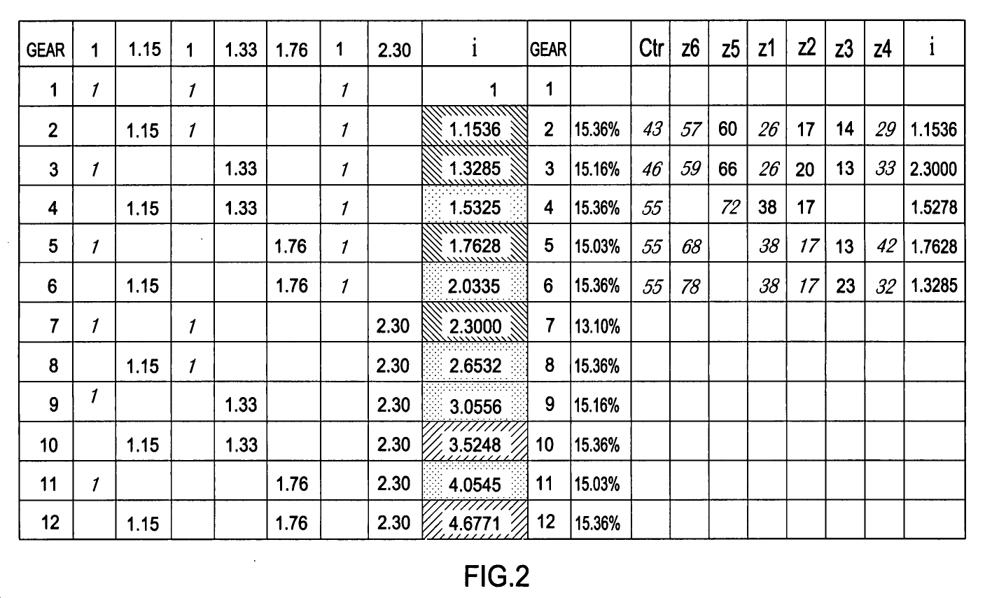

FIG. 2 is a table of gear ratios. Planetary mechanism (carrier) 100 has gear ratios 1, 1.33, and 1.76. Planetary mechanism 200 has gear ratios 1 and 1.15. Planetary mechanism 300 has gear ratios 1 and 2.30. The combined overall gear ratio is noted in column i.

The inventive transmission results in very linear steps between each gear ratio averaging approximately 15%. This allows predictable power requirements for each shift as a rider shifts up and down through the gears.

Since the inventive transmission increases the speed of the output member front sprocket 44 compared to the speed of input member 22, the ratio between the front sprocket 44 and a rear sprocket 36 installed on the rear wheel 34 is adjusted accordingly. Hence, for example, front sprocket 44 has 32 teeth and the rear sprocket has 42 teeth. The number of teeth on the front sprocket and rear sprocket may be adjusted as may be required by a user.

FIG. 3 is a table of brake and clutch positions for each gear. For example, first gear, the slowest gear, has all planetary mechanisms 100, 200, 300 at gear ratio 1:1 and all clutches CL1, CL2, CL3, are locked. In first gear all brakes 1, 2, 3, 4 are disengaged.

The inventive transmission is about 20%-30% lighter than prior art transmissions. Another advantage of the transmission is better clearance in a bicycle frame since front sprocket is much smaller.

The following is provided as an example and is not intended to limit the design parameters which may be used for each component. The diameters are in mm.

| Pinion Gear | Ring Gear | Diameter | No. of Teeth |
|---|---|---|---|
| P1 | NA | 13.6 | 17 |
| P2 | NA | 18.4 | 23 |
| P3 | NA | 10.4 | 13 |
| P4 | NA | 11.2 | 14 |
| P5 | NA | 13.6 | 17 |
| P6 | NA | 16 | 20 |
| P7 | NA | 10.4 | 13 |
| NA | R1 | 57.6 | 72 |
| NA | R2 | 45.6 | 57 |
| NA | R3 | 48 | 60 |
| NA | R4 | 52.8 | 66 |

FIG. 4 is a partial side view of a bicycle. The inventive transmission will be preferably installed in bottom bracket 20. Crank arms 41 are connected to input member 22. A rider's feet engage pedals 42. A flexible drive member 50 is engaged between sprocket 44 and rear sprocket 36. Rear sprocket 36 is connected to wheel 34. A rider (not shown) sits on seat 24. Wheel 34, crank arms 41, bottom bracket 20, seat 24 are connected to bicycle frame 30, known in the art.

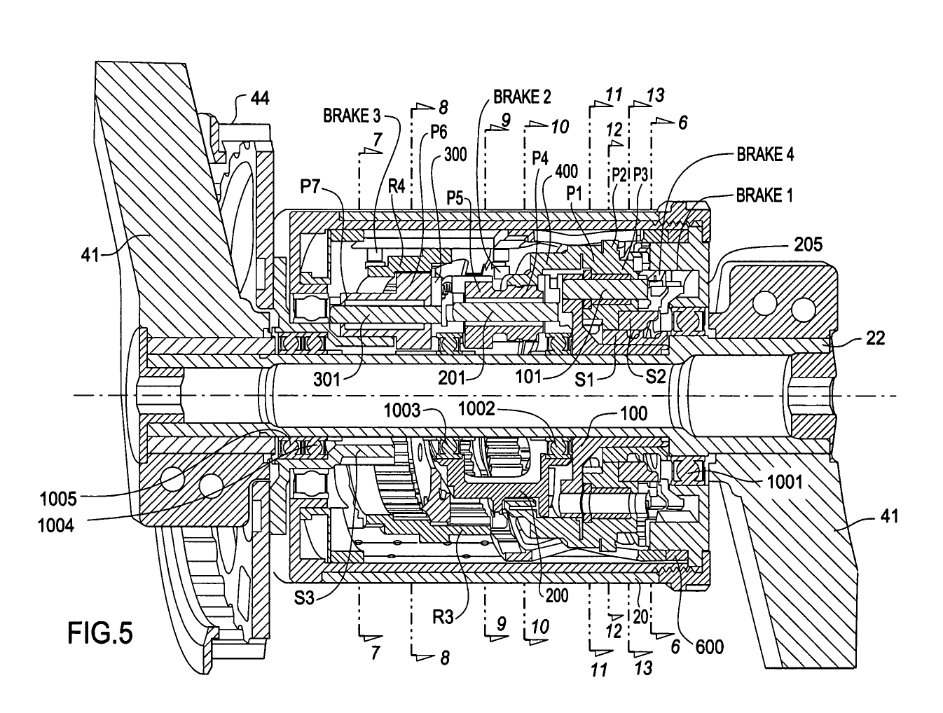

FIG. 5 is a cross-sectional view of the transmission. Planetary carrier mechanisms 100, 200, 300 are shown connected in series within bottom bracket or a transmission housing 20. Carrier 100 is fixedly connected to input member 22. Carrier 200 is rotatable about member 22 on bearings 1002, 1003. Carrier 300 is rotatable about member 22 on bearings 1003, 1004, 1005. Member 22 rotates within bottom bracket 22 on bearing 1001. Member 22 may be hollow to reduce weight of the transmission.

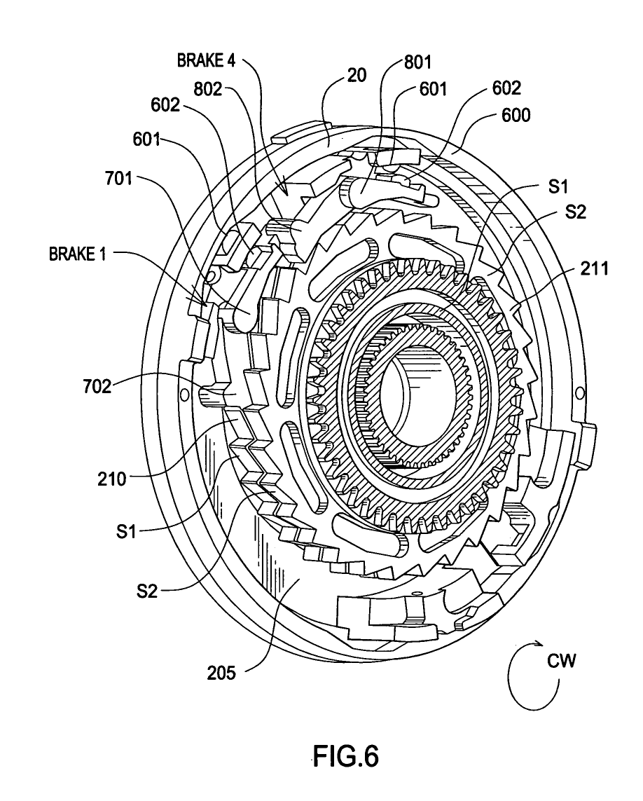

FIG. 6 is a perspective view of a brake. The figure shows sun gears S1 and S2. Brake 1 engages sun gear S1. Brake 4 engages sun gear S2.

Each brake 1 and brake 4 comprises a shift member 701 and 801 respectively. Shift cam 600 engages shift rollers 601. Each shift roller 601 engages a compliant pad 602.

Each shift member 701 and 801 are pivotally mounted to end cap 205. Each end 702, 802 of each shift member 701, 801 engages sun gear teeth 210, 211 respectively.

On operation, shift cam 600 rotates causing each shift roller 601 to move radially inward, thereby pressing upon each complaint pad 602. Pressing upon each complaint pad 602 causes each shift member 701, 801 to pivot thereby causing it to engage sun gear teeth 210, 211 respectively. Engagement of each shift member 701, 801 with the respective sun gear teeth stops rotation of the respective sun gear in a clockwise direction CW.

The reaction force caused by engagement of the shift members 701, 801 with teeth 210, 211 is transmitted through each shift member 701, 801 to the end cap 205 and thereby to the bicycle frame.

Brake 2 and brake 3 are identical in description and operation to brake 1 and brake 4.

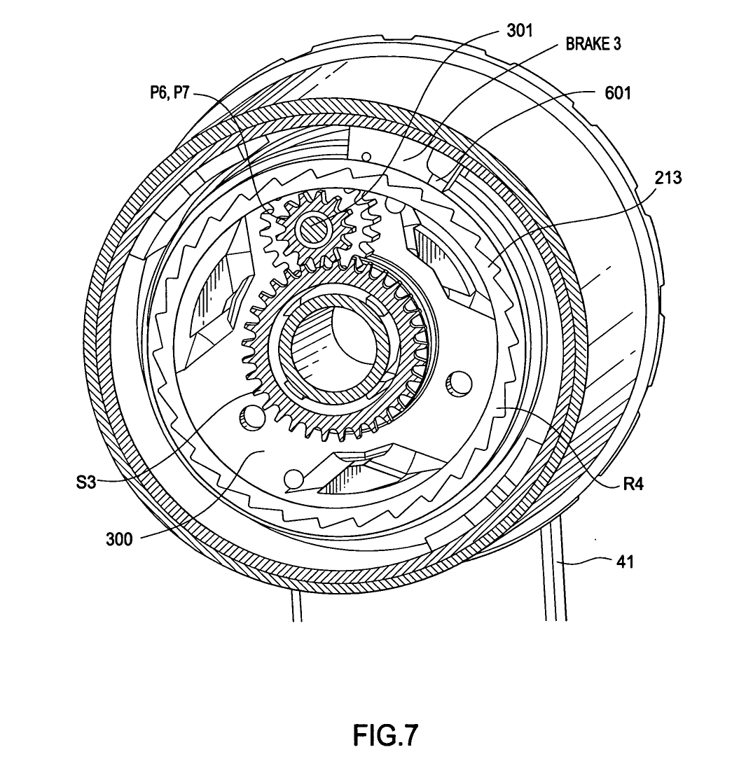

FIG. 7 is a cross-section at 7-7 in FIG. 5. Pinion gear P7 has a meshing engagement with sun gear S3. Brake 3 shift member 601 engages teeth 213. Teeth 213 are disposed on an outer perimeter of ring gear R4. In the instant embodiment there are three sets of pinion gears P6, P7.

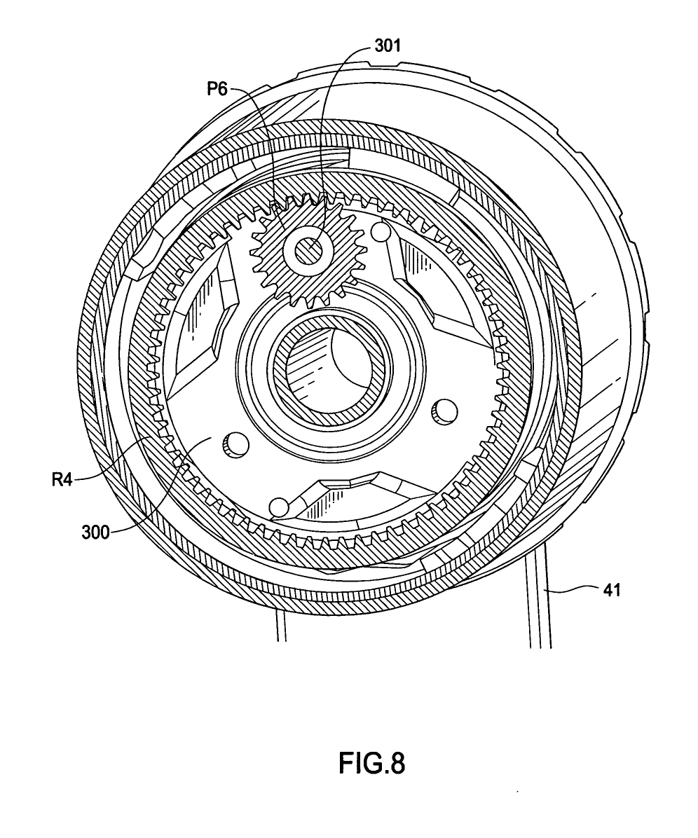

FIG. 8 is a cross-section at 8-8 in FIG. 5. Pinion gear P6 is journalled to pin 301.

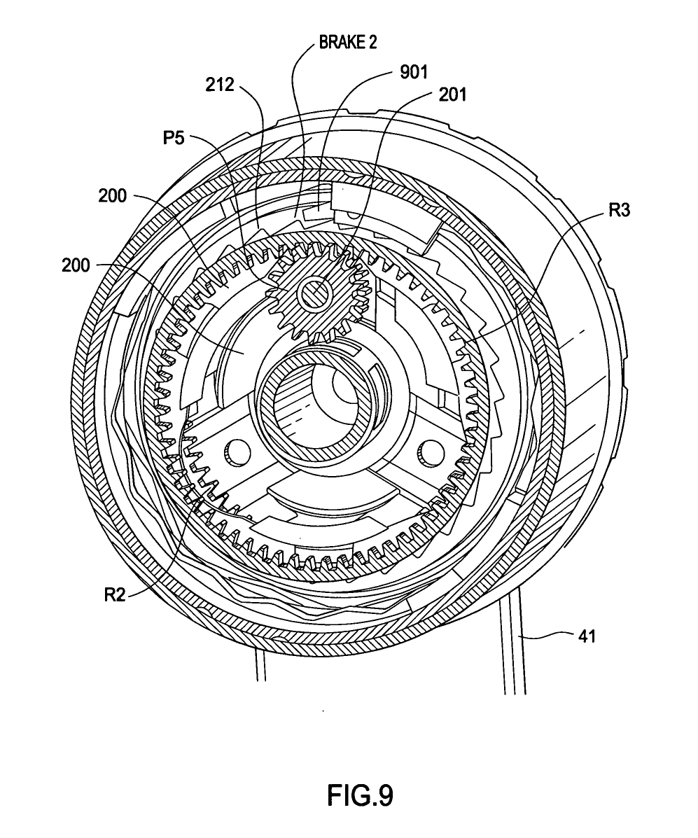

FIG. 9 is a cross-section at 9-9 in FIG. 5. Pinion gear P5 is journalled to pin 201. Pinion gear P5 has a meshing engagement with ring gear R3. Brake 2 comprises shift member 901 which engages teeth 212. Teeth 212 are disposed on an outer perimeter of carrier 200. In the instant embodiment there are three sets of pinion gears P4, P5.

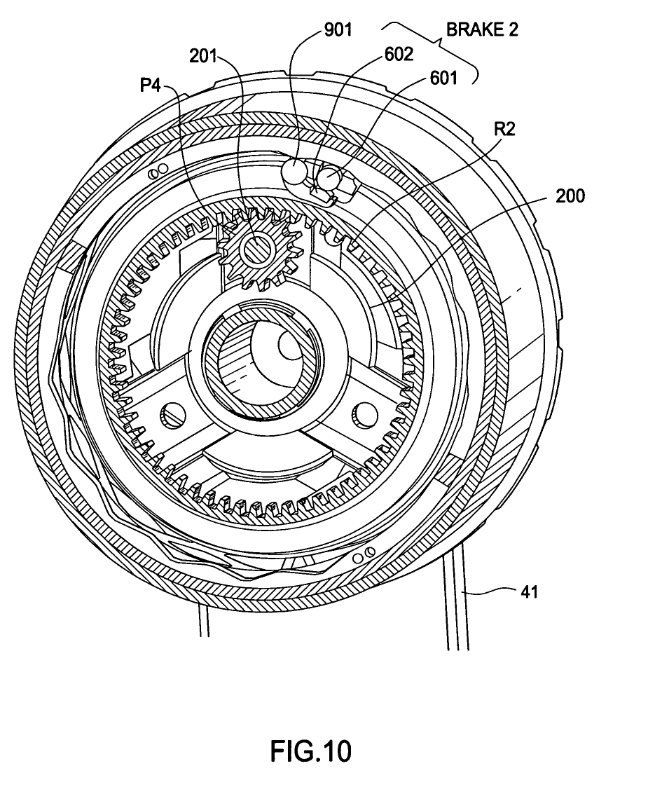

FIG. 10 is a cross-section at 10-10 in FIG. 5. Pinion gear P4 has a meshing engagement with ring gear R2.

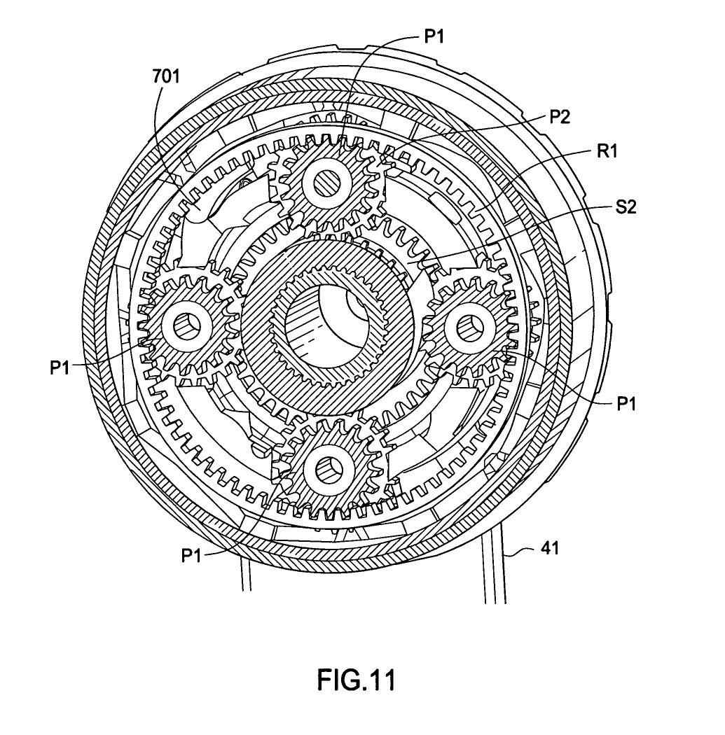

FIG. 11 is a cross-section at 11-11 in FIG. 5. Pinion gear 1 and P2 are journalled to pin 101. Pinion gear P1 has a meshing engagement with ring gear R1. In the instant embodiment there are four sets of pinion gears P1, P2, P3, each journalled to a pin 101.

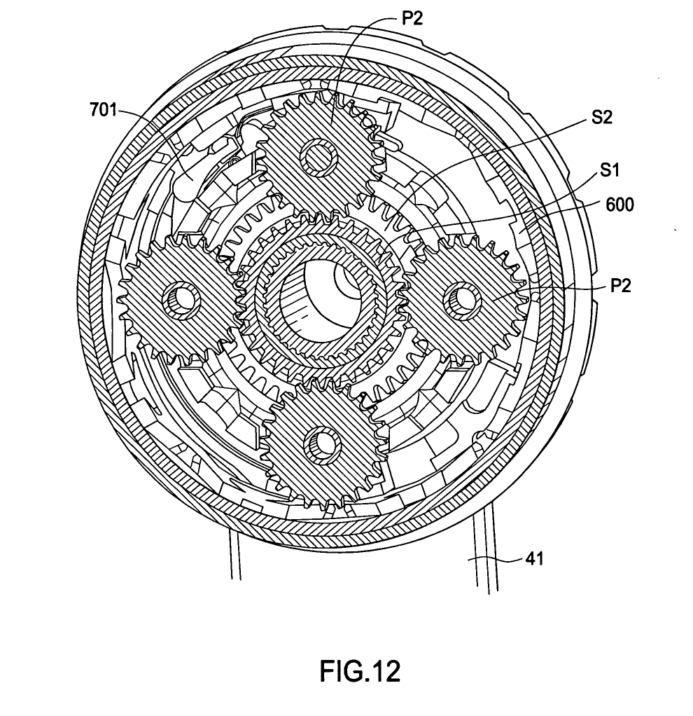

FIG. 12 is a cross-section at 12-12 in FIG. 5. Sun gear S1 has a meshing engagement with pinion gear P2. Sun gear S2 has a meshing engagement with pinion gear P3.

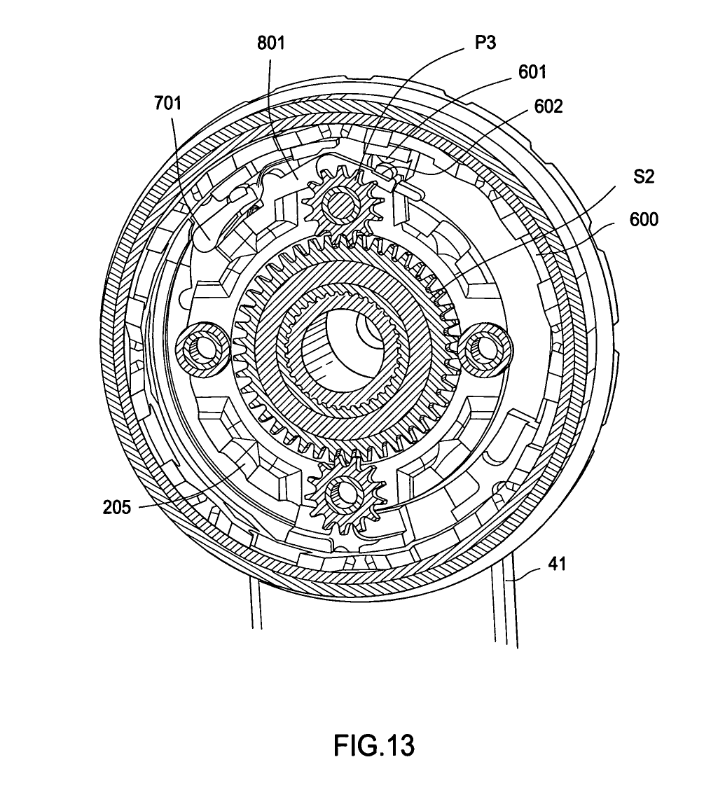

FIG. 13 is a cross-section at 13-13 in FIG. 5. Pinion gear P3 has a meshing engagement with sun gear S2.

Although a form of the invention has been described herein, it will be obvious to those skilled in the art that variations may be made in the construction and relation of parts without departing from the spirit and scope of the invention described herein.

We claim:

1. A planetary gear mechanism comprising:
an input member (22);
a first carrier (100) having a first carrier first pinion gear (P1) and a first carrier second pinion gear (P2), each journalled to the first carrier, the first carrier rotationally fixed to the input member (22), the first carrier second pinion gear (P2) engaged with a first brake (Brake 1) through a sun gear (S1);
a second carrier (200) having second carrier first pinion gear (P4) and a second carrier second pinion gear (P5), each pinion gear (P4) and (P5) is journalled to the second carrier, the second carrier engaged with a second brake (Brake 2);
a first ring gear (R1) in meshing engagement with the first carrier first pinion gear (P1), a second ring gear (R2) in meshing engagement with the second carrier first pinion gear (P4), the first ring gear and second ring gear comprise a ring gear member (400);
a third carrier (300) having a third carrier first pinion gear (P6) and a third carrier second pinion gear (P7), each pinion gear (P6) and (P7) is journalled to the third carrier;
a third ring gear (R3) in meshing engagement with the second carrier second pinion gear (P5), the third ring gear fixedly connected to the third carrier (300);
a fourth ring gear (R4) engaged with a third brake (Brake 3) and in meshing engagement with the third carrier first pinion gear (P6);
a first one-way clutch (CL1) engaged between the first carrier (100) and the ring gear member (400);
a second one-way clutch (CL2) engaged between the second carrier (200) and the ring gear member (400);
a third one-way clutch (CL3) engaged between the third carrier (300) and the fourth ring gear (R4); and
an output member (44) in meshing engagement with the third carrier second pinion gear (P7).

2. The planetary gear mechanism as in claim 1 further comprising:
a first carrier third pinion gear (P3); and
a sun gear (S2) in meshing engagement with a first carrier third pinion gear (P3); and
a fourth brake (Brake 4) engaged with the sun gear (S2).

3. The planetary gear mechanism as in claim 1, wherein the planetary gear mechanism is integrated into a bicycle frame.

4. The planetary gear mechanism as in claim 1, wherein the first carrier is connected coaxially in series to the second carrier, which second carrier is connected coaxially in series to the third carrier.

5. The planetary gear mechanism as in claim 1, wherein the first brake comprises a pivoting shift member for releasably engaging a tooth on the sun gear (S1).

6. The planetary gear mechanism as in claim 1, wherein the second brake comprises a pivoting shift member for releasably engaging a tooth on the second carrier.

7. The planetary gear mechanism as in claim 1, wherein the third brake comprises a pivoting shift member for releasably engaging a tooth on the ring gear (R4).

8. The planetary gear mechanism as in claim 1, wherein the fourth brake comprises a pivoting shift member for releasably engaging a tooth on the sun gear (S2).

9. A planetary gear mechanism comprising:
an input member connected to a first planetary mechanism;
the first planetary mechanism connected coaxially in series to a second planetary mechanism, which second planetary mechanism is connected coaxially in series to a third planetary mechanism;
the second planetary mechanism output is a step up in speed from the first planetary mechanism output, the third planetary mechanism output is a step up in speed from the second planetary mechanism output; and
the third planetary mechanism connected to an output member.

10. A bicycle comprising:
a frame (30);
a planetary gear transmission comprising an input member (22), a first planetary mechanism, a second planetary mechanism and a third planetary mechanism, and an output member (44);
the first planetary mechanism, second planetary mechanism and third planetary mechanism are each connected in series; and
a flexible drive member (50) drivingly engaged between the output member (44) and a wheel (34).

11. The bicycle as in claim 10, wherein:
the input member is connected to the first planetary mechanism;
the second planetary mechanism rotary output is a step up in speed from the first planetary mechanism rotary output, the third planetary mechanism rotary output is a step up in speed from the second planetary mechanism rotary output; and
the third planetary mechanism is connected to the output member.
